(19) United States
(12) Patent Application Publication
(10) Pub. No.: US 2009/0108998 A1
(43) Pub. Date: Apr. 30, 2009

(54) Automatic reporting of configuration of a remote unit

(75) Inventors: Sean M. SMITH, Wilkes-Barre, PA (US); David W. OLIVETTI, SR., Dunmore, PA (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation, Bethesda, MD (US)

(21) Appl. No.: 11/976,707

(22) Filed: Oct. 26, 2007

(51) Int. Cl. H04Q 5/22

(52) U.S. Cl. 340/10.1

(57) ABSTRACT

Configuration information of a remote unit can be interrogated by an external interrogator. An embodiment of the remote unit includes an interrogation memory operatively connected to an interrogation interface device. When the remote unit is programmed with software/firmware to establish a remote unit configuration, the configuration information corresponding to the remote unit configuration may be stored into the interrogation memory. Upon receiving an interrogation signal from the external interrogator, the interrogation interface device may wirelessly communicate the configuration information to the external interrogator.

### FIELD OF THE INVENTION

This invention relates generally to systems and methods of monitoring a configuration of a remote unit. Configuration information of the remote unit can be interrogated by an external interrogator.

### BACKGROUND OF THE INVENTION

When remote units containing field-programmable components are programmed, configuration information corresponding to the programming or re-programming can be maintained. The configuration information can be maintained manually through a log. The configuration information can also be maintained in a database. When a remote unit is programmed, the corresponding information may be entered in the database manually or through an automated process.

When it is desired to check the programmed configuration of the remote unit, the log or the database may be consulted. Maintaining the log or the database of configuration information manually is error prone since this involves a separate, manual process to enter the configuration information. Accordingly, the configuration information retrieved from the log or the database is also prone to error.

Some field-programmable remote units include a controller that operates to control the operation of the field-programmable components within the remote unit. When there is an update to software, firmware, or programmable hardware the field device controller is programmed with the updated software/firmware in a program memory of the field device controller. The programming can be performed by one or more support equipment external to the remote unit. In the process of programming the remote unit with the updated software/firmware, the version or identity of the software/firmware is written in the configuration memory of the field device controller.

When it is desired to check the version or identity of the software/firmware written in the program memory of the remote unit, the remote unit is powered up and a query is made to display the version or identity. In some instances, the support equipment is required to interface with the remote unit to power on the field-programmable components and to query for the version or identify information. Thus, multiple steps and much support can be required to determine the version or identity information. Accordingly, this process can be subject to error and is cumbersome.

### SUMMARY OF THE INVENTION

An exemplary embodiment of a method of monitoring a configuration of a remote unit may include programming the remote unit with software/firmware to establish a remote unit configuration. The method may also include storing configuration information corresponding to the remote unit configuration into a memory of the remote unit operatively connected with an interrogation interface device of the remote unit. The interrogation interface device can be externally activated by an external interrogator and can wirelessly communicate the configuration information from the memory to the external interrogator upon receiving an interrogation signal from the external interrogator.

An exemplary embodiment of a remote unit of the present invention may include a programming controller configured to control the programming of the remote unit, and may include a program memory configured to store the program of the remote unit. The program memory can be operatively connected to the programming controller. The remote unit may also include an interrogation memory that is operatively connected to the programming controller and configured to store the configuration data for the remote unit. The programming controller can be configured to program the program memory with software/firmware that establishes a remote unit configuration and can be configured to store configuration information corresponding to the remote unit configuration into the interrogation memory. The exemplary remote unit may further include an interrogation interface device operatively connected to the programming controller. The interrogation interface device can be configured to be externally activated by an external interrogator and configured to wirelessly communicate the configuration information from the interrogation memory to the external interrogator upon receiving an interrogation signal from the external interrogator.

An exemplary embodiment of a support equipment of the present invention for programming a remote unit may include a programming module. The programming module may be configured to program the remote unit with software/firmware to establish a remote unit configuration. The programming module may also be configured to store configuration information corresponding to the remote unit configuration into a memory of the remote unit operatively connected with an interrogation interface device of the remote unit. The interrogation interface device of the remote unit may be configured to be externally activated by an external interrogator and may be configured to wirelessly communicate the configuration information from the memory to the external interrogator upon receiving an interrogation signal from the external interrogator.

### BRIEF DESCRIPTION OF THE DRAWING FIGURES

FIG. 1A illustrates an exemplary embodiment of a system for monitoring a configuration of a remote unit and an external programmer;

FIG. 1B illustrates an exemplary embodiment of a remote unit;

FIG. 2 illustrates an exemplary embodiment of a timeline of a process to program a remote unit and to retrieve configuration information from the remote unit;

FIG. 3 illustrates an exemplary embodiment of interrogation memory contents;

FIG. 4 is a flow chart illustrating an exemplary embodiment of a method of programming a remote unit;

FIG. 5 is a flow chart illustrating an exemplary embodiment of a method of interrogating a remote unit; and

FIGS. 6A-6D are flow charts illustrating exemplary embodiments of programming a remote unit.

### DETAILED DESCRIPTION OF THE INVENTION

For simplicity and illustrative purposes, the principles of the invention are described by referring mainly to exemplary embodiments thereof. However, one of ordinary skill in the art would readily recognize that the same principles are equally applicable to many types of updating and monitoring configuration information of remote units.

Remote units refer generally to devices and/or apparatus that contain, or are themselves, field-programmable components and come in many forms. An example of a remote unit is a portable medical device such as an ultrasound machine. Other examples include munitions guidance systems, portable cellular phones, engine control units for automobiles, Global Positioning System (GPS) receivers, and integrated Inertial Measurement Units (IMU).

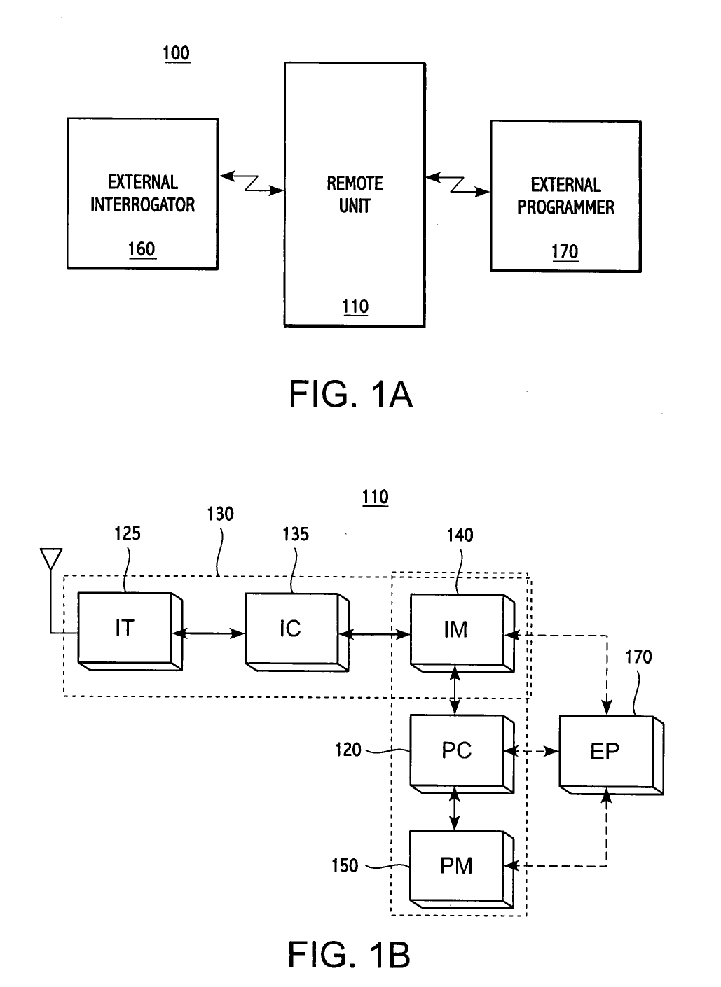

FIG. 1 illustrates an exemplary embodiment of a system 100 for monitoring a configuration of a remote unit 110. As illustrated, the system includes a remote unit 110, an external interrogator 160 and an external programmer 170. During normal operation, the remote unit 110 need not be connected to either the external interrogator 160 or the external programmer 170. The external interrogator 160 may issue a configuration information request command to the remote unit 110 during an interrogation operation. The external programmer 170 may initiate reprogramming operation and provide programming data to the remote unit 110.

FIG. 1B illustrates an exemplary embodiment of the remote unit 110. The exemplary remote unit 110 may include an interrogation transceiver 125, an interrogation controller 135 and an interrogation memory 140, a programming controller 120, and a program memory 150.

The interrogation transceiver 125 may be configured to receive commands from the external interrogator 160 (not shown in FIG. 1B) and to transmit responses back. The responses may be modulated by the interrogation controller 135. The interrogation controller 135 may be configured to interpret the commands received from the external interrogator 160 and to generate appropriate responses, retrieving information from the interrogation memory 140 when necessary. The interrogation memory 140 may be configured to store configuration information. The program controller 120 can be configured to reprogram the program memory 150 and update the configuration information in the interrogation memory 140. The program memory 150 may store software instructions, data and hardware control values. The program memory 150 can be any type of reprogrammable devices including flash memory, FPGA memory, CPLDs, EEPROM, etc. The remote unit 110 may include a plurality of reprogrammable devices in any combination. Note that the external programmer 160 can also directly update the program memory 150 and/or the interrogation memory 140.

The combination of the interrogation transceiver 125, the interrogation controller 135 and the interrogation memory 140 may be referred to as an interrogation interface device 130. The interrogation interface device 130 can wirelessly communicate with the external interrogator 160 such as responding to an interrogation request.

Within the remote unit 110, the interrogation interface device 130 is operatively connected to the programming controller 120. For example, the programming controller 120 can be operatively connected to the interrogation controller 135 and/or the interrogation memory 140. The connection between the programming controller 120 and the interrogation interface device 130 may be wired or wireless. The interrogation memory 140 can be non-volatile and/or rewritable.

Various physical arrangements are possible for the remote unit 110. For example, the interrogation transceiver 125, the interrogation controller 135 and the interrogation memory 140 can be fabricated on a same semiconductor die. As an alternative, the interrogation memory 140 can be located on a circuit card assembly separate from the interrogation controller 135.

The programming controller 120 is configured to control the operation of the remote unit 110, for example through software/firmware program stored in the program memory 150. The program memory 150 can be configured so that it can be updated with new software/firmware.

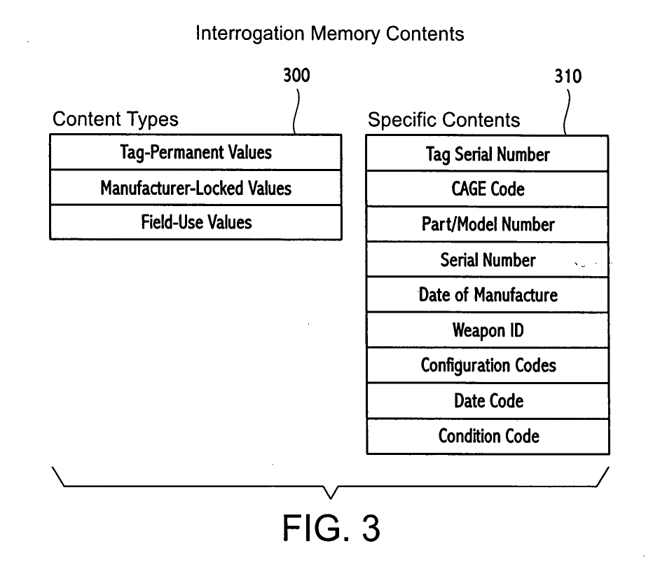

Each programming (updating) can establish a remote unit configuration for the remote unit 110, where each remote unit configuration is identified with corresponding configuration information 300, 310. The configuration information 300, 310 can be stored in the interrogation memory 140. Exemplary contents of the configuration information 300, 310 will be discussed below with reference to FIG. 3.

The interrogation interface device 130 may be configured to be externally activated by an external interrogator 160. In the exemplary embodiment, the interrogation interface device 130 is configured to wirelessly communicate the configuration information 300, 310 from the memory 140 to the external interrogator 160 upon receiving a designated interrogation signal from the external interrogator 160 (see also steps 510, 520 and 530 in FIG. 5).

In an embodiment, the interrogation interface device 130 may be passive. In other words, the passive interrogation interface device 130 is configured to capture energy from the interrogation signal transmitted from the external interrogator 160. The passive interrogation interface device 130 retrieves the configuration information 300, 310 from the interrogation memory 140 and/or wirelessly transmits the configuration information 300, 310 using the captured energy of the interrogation signal (see also step 540 in FIG. 5). For example, the interrogation transceiver 125 can receive the RF energy from the external interrogator 160 and condition it for processing by the interrogation controller 135, which in turn accesses the interrogation memory 140 to retrieve the configuration information 300, 310. The interrogation transceiver 125 can also retransmit the RF energy as modulated by the interrogation controller 135.

With the passive interrogation interface device 130, the remote unit 110 need not be powered up to retrieve and/or transmit the configuration information 300, 310 to the external interrogator 160. To state it another way, the interrogation interface device 130 may be configured to communicate with the external interrogator 160 without utilizing a main power from the remote unit 110.

An example of the passive interrogation interface device 130 is a passive radio frequency identification (RFID) tag device. In this instance, the external interrogator 160 can be a RFID tag reading device and the interrogation signal is a RF interrogation signal from the RFID tag reading device.

In another embodiment, the interrogation interface device 130 may include a power source dedicated to the interrogation interface device 130 apart from the main power from the remote unit 110. As an example, a battery may be dedicated to power the interrogation interface device 130. The interrogation interface device 130 can be configured to retrieve the configuration information 300, 310 and/or wirelessly transmit the configuration information 300, 310 to the external interrogator 160 using power from the dedicated power source without utilizing the main power from the remote unit 110.

If the interrogation interface device 130 can use the dedicated power source, the range of transmission of the configuration information 300, 310 to the external interrogator 160, and consequently, a range of interrogation may be increased. Where there are a plurality of remote units 110, the plurality of remote units 110 may be interrogated simultaneously with one interrogation signal from the external interrogator 160. Simultaneous interrogation is also possible with remote units 110 with passive interrogation interface devices 130, but the interrogation range may be reduced in comparison.

As illustrated in FIG. 1B, the remote unit 110 may include the program memory 150 operatively connected with the programming controller 120. Again, various physical arrangements are possible. As an example, the program memory 150 can be embedded in one or more remote unit components, including but not limited to the programming controller 120. The program memory 150 may also be non-volatile and/or rewritable.

The remote unit 110, and in particular the program memory 150, may be programmed a plurality of times during its life cycle. The remote unit 110 can be initially programmed with the software/firmware at a point of manufacture such as a factory. Also as noted above, the configuration information 300, 310 can be stored in the interrogation memory 140.

During normal operation, the remote unit 110 may interface with a parent equipment (not shown). As an example, the remote unit 110 may be a munitions guidance apparatus designed to guide munitions to a target. The munitions may be attached to a host aircraft at a store station and the munitions guidance apparatus can interface with a munitions control system on the aircraft. In this instance, the munitions control system on the aircraft is an example of the parent equipment. Another example is a GPS receiver interfacing with an aircraft navigation computer.

In addition to being programmed at the point of manufacture, the remote unit 110 may also be programmed with the software/firmware in the field. As illustrated in FIGS. 1A and 1B, the remote unit 110 interfaces with an external programmer 170. The external programmer 170 may be configured to program/update the remote unit 110, and in particular the program memory 150, with the updated software/firmware. It is noted that the external programmer 170 can also be used to initially program the remote unit 110 at the point of manufacture as well as to subsequently program the remote unit 110 in the field.

As illustrated in FIG. 1B, the external programmer 170 can be operatively connected to one or more of the programming controller 120, the program memory 150 and the interrogation memory 140. The connections may be wired or wireless. In one embodiment, the external programmer 170 would provide the updated program information to the program controller 120 and the program controller would in turn operate to update the program memory 150 with the updated program and update the interrogation memory 140 with the updated configuration information 300, 310.

However, if a connection between the external programmer 170 and the interrogation memory 140 is available, then the external programmer 170 can write the configuration information 300, 310 directly into the interrogation memory 140. Similarly, a connection between the external programmer 170 and the program memory 150 would allow the external programmer 170 to directly update the program in the program memory 150. The options to directly access the interrogation memory 140 and/or the program memory 150 can be available whether or not the program controller 120 is capable of performing the same functions.

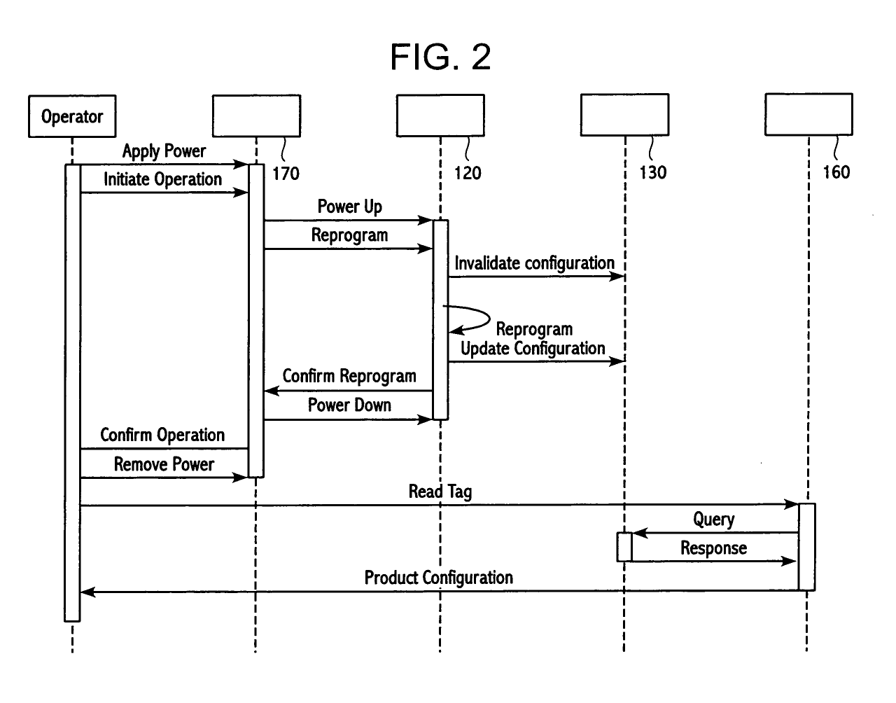

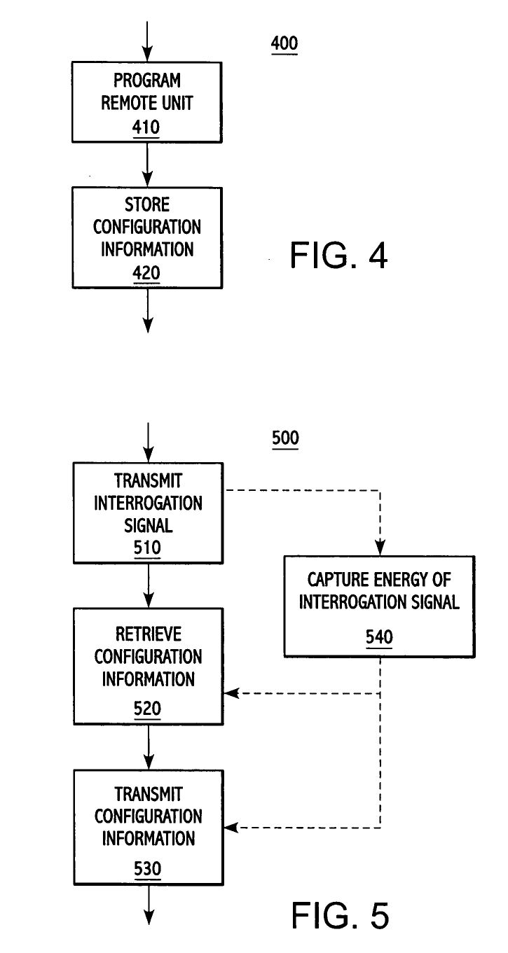

FIG. 2 illustrates an exemplary embodiment of a timeline of a process to program the remote unit 110 with the software/firmware and to retrieve configuration information 300, 310 from the remote unit 110. Also, FIGS. 4, 5 and 6A-6D are flow charts illustrating exemplary embodiments of programming and interrogating the remote unit 110.

When the remote unit 110 is powered up, the external programmer 170 may automatically establish communications with the remote unit 110, and in particular, may automatically establish communications with the programming controller 120. The external programmer 170 may prompt the operator to power on the remote unit 110 if it detects that the remote unit 110 is not powered. Alternatively, the external programmer 170 may automatically cause the remote unit 110 to power on.

The external programmer 170 may proceed with the remote unit 110 programming process after the communication is established with the programming controller (steps 410 and 420 of FIG. 4). In an embodiment of the invention, the external programmer 170 provides the software/firmware to the programming controller 120 and the programming controller 120 proceeds to program the remote unit 110, for example, by storing the software/firmware in the program memory 150. In another embodiment, the external programmer 170 may directly program the remote unit 110, for example, also by storing the software/firmware directly in the program memory 150.

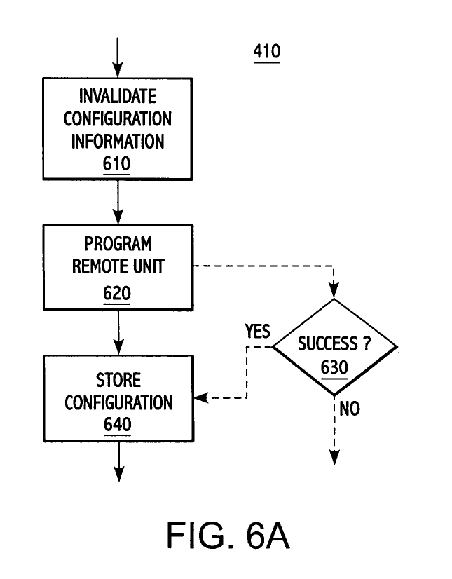

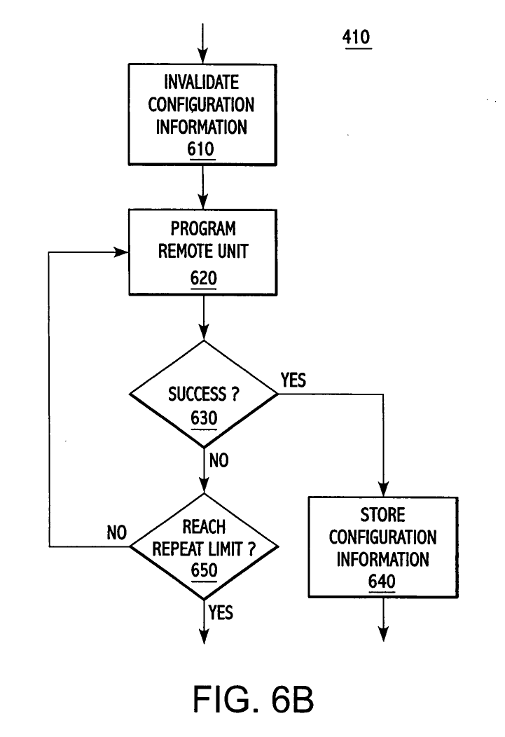

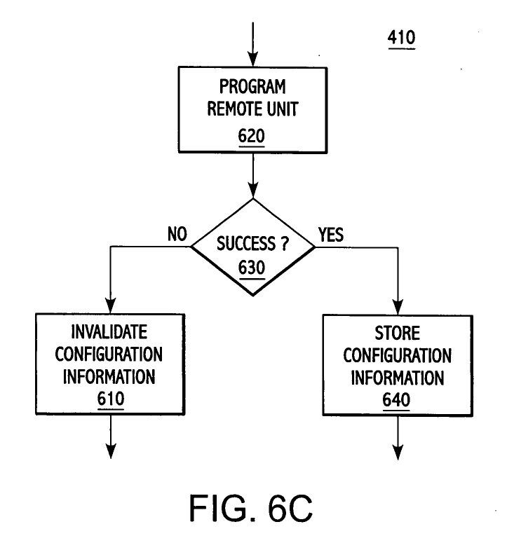

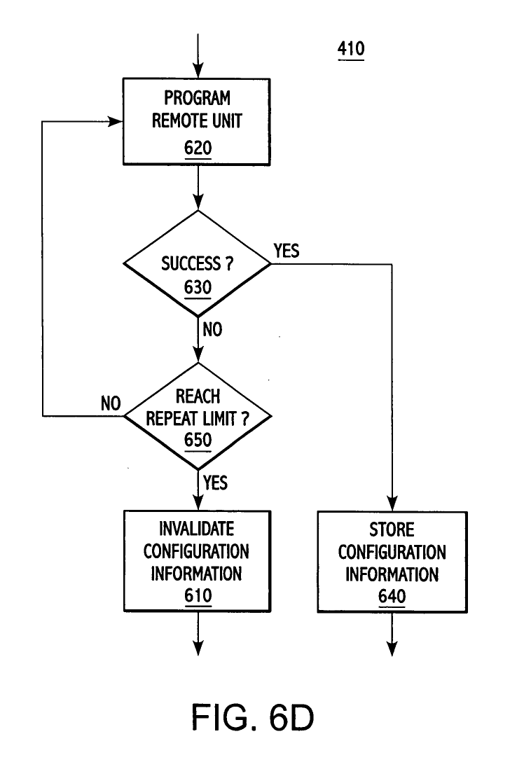

Preexisting configuration information 300, 310 that have been stored in the interrogation memory 140 may be invalidated prior to modifying the program memory 150 of the remote unit 110 (step 610 in FIGS. 6A and 6B). For example, the programming controller 120 or the external programmer 170 may write data indicating invalid configuration into the interrogation memory 140.

Invalidating the configuration information 300, 310 prior to programming has at least the following advantages. During the programming process, the preexisting configuration information 300, 310 stored in the memory 140 is unlikely to correspond to the updated software/firmware being currently programmed into the remote unit 110. When an interrogation signal is received from the external interrogator 160 during programming, an accurate state of the configuration information 300, 310 may be transmitted—namely, that the configuration is invalid. Also, if the programming is not successful, again an accurate state may be presented to the external interrogator 160 after the unsuccessful programming attempt completes.

After successful programming of the remote unit 110, the configuration information 300, 310 that corresponds to the programmed software/firmware may be stored in the interrogation memory 140 (step 640 in FIGS. 6A and 6B). For example, the programming controller 120 or the external programmer 170 may write the corresponding configuration information 300, 310 into the interrogation memory 140.

The programming process may include confirming whether or not the remote unit 110 has been successfully programmed (step 630 in FIGS. 6A and 6B). In this instance, the corresponding configuration information 300, 310 can be stored in the interrogation memory 140 after confirming that the remote unit 110 has been successfully programmed (step 640 in FIGS. 6A and 6B).

The confirmation may include verifying contents of the program memory 150. In one embodiment, verifying contents may include reading out the contents of the program memory 150 for comparison. In another embodiment, a cyclic redundancy code (CRC) may be calculated and verified. Other known verification techniques may be utilized. One or both of the programming controller 120 and the external programmer 170 may perform the verification.

If it is not confirmed that the remote unit 110 has been successfully programmed, then the process of programming and confirming may be repeated a predetermined number of times, for example 10 times (steps 620, 630 and 650 in FIG. 6B). If any of the repeated attempts is successful, then the corresponding configuration information 300, 310 may be stored into the memory (step 640 in FIG. 6B). The number of repeat attempts may be reconfigurable as desired including zero. When set to zero, no repeat attempts will be made to program the remote unit 110 during a given programming session.

As noted above, any preexisting configuration information 300, 310 that may have been stored in the interrogation memory 140 may be invalidated prior to programming the remote unit 110. This is not strictly necessary.

In another embodiment, the programming of the remote unit 110 may commence without first invalidating the configuration information 300, 310 stored in the interrogation memory 140 (step 620 in FIGS. 6C and 6D). That is, the programming controller 120 or the external programmer 170 proceeds to update the software/firmware into the program memory 150 without first invalidating the configuration information 300, 310 in the memory 140. In this instance, depending on whether the programming is successful or not, data indicating valid configuration information 300, 310 or data indicating invalid configuration may be stored to the interrogation memory 140.

The programming process may include the verification process as described above (step 630 in FIGS. 6C and 6D). When it is verified that the remote unit 110 has been successfully programmed, the configuration information 300, 310 that corresponds to the programmed software/firmware may be stored in the interrogation memory 140 (step 640 in FIGS. 6C and 6D). Again, the programming controller 120 or the external programmer 170 may write the corresponding configuration information 300, 310 into the interrogation memory 140.

If it is not verified that the remote unit 110 has been successfully programmed, the data indicating invalid configuration may be stored into the interrogation memory 140 by any of the programming controller 120, the external programmer 170, or the interrogation controller (step 610 in FIGS. 6C and 6D).

As an alternative, the process of programming and verifying may be repeated a predetermined number of times if it is not initially verified that the remote unit 110 has been successfully programmed as described above (steps 620, 630 and 650 in FIG. 6D). If any of the repeated attempts is successful, then the corresponding configuration information 300, 310 may be stored into the interrogation memory (step 640 in FIG. 6D). If none of the repeated attempts are successful, then the data indicating invalid configuration may be stored into the interrogation memory 140 (step 610 in FIG. 6D).

When the remote unit 110 is programmed, the configuration information 300, 310 may be stored in the interrogation memory 140 contemporaneously, for example, by the programming controller 120 or the external programmer 170. In other words, the configuration information 300, 310 may be stored into memory 140 when the remote unit 110 is programmed without requiring a manual intervention from the operator to separately initiate the process to store the configuration information 300, 310.

FIG. 3 illustrates an exemplary embodiment of contents of configuration information 300, 310. The configuration information 300 may include one or types of values including tag-permanent values, manufacturer-locked values, and field-use values. The configuration information 310 may include one or more specific instances of types of values.

The tag-permanent values can include values of characteristics that are specific to the interrogation interface device 130. The tag-permanent values may be permanent, i.e., do not change during the life of the interrogation interface device 130. For example, the tag-permanent values may include an identification of the interrogation interface device 130, such as a serial number, that uniquely identifies the interrogation interface device 130.

The manufacturer-locked values can include values of interest to and controlled by the manufacturer with regard to the remote unit 110. The manufacturer-locked values may be permanent or may change during the life of the remote unit 110. Examples of manufacturer-locked values include a CAGE code, a part/model identification, a serial identification, a date of manufacture, and/or an identification information. Manufacturer-locked values can be changeable by the manufacturer of the remote unit 110. For example, the manufacturer-locked values can be changed only by the manufacturer when significant alterations, such as hardware replacements or retrofits, are made to the remote unit 110 that are above and beyond field-reprogramming.

The field-use values include values of characteristics that identify a state of the remote unit 110. The field-use values are likely to change during the life cycle of the remote unit 110. Examples of field-use values include a configuration code, a date code, and/or a condition code. The configuration code may include an identification of a version of the software/firmware stored in the program memory 140 and/or a list of particular software/firmware functions that have been updated. The date code may include a date of distribution of the software/firmware and/or a date in which the remote unit 110 was programmed with the software/firmware. The condition code may include historical information and other information on the state of the remote unit 110 such as when the remote unit 110 was tested, the results of the test, and identification of equipments used in the test. Historical information may also include the number of times the remote unit was programmed, the time/date of each programming event, the results of each programming, activation by parent equipment, etc.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of monitoring a configuration of a remote unit, comprising:
programming the remote unit with software/firmware to establish a remote unit configuration; and
storing configuration information corresponding to the remote unit configuration into a memory of the remote unit operatively connected with an interrogation interface device of the remote unit,
wherein the interrogation interface device is configured to be externally activated by an external interrogator, and to wirelessly communicate the configuration information from the memory to the external interrogator upon receiving an interrogation signal from the external interrogator.

2. The method of claim 1, comprising:
wirelessly transmitting the interrogation signal from the external interrogator to the interrogation interface device;
retrieving the configuration information from the memory utilizing the interrogation interface device upon receipt of the interrogation signal from the external interrogator; and
wirelessly transmitting the retrieved configuration information from the interrogation interface device to the external interrogator.

3. The method of claim 2, wherein the interrogation interface device is a passive interrogation interface device, the method comprising:
capturing energy from the interrogation signal transmitted from the external interrogator; and
performing, via the passive interrogation interface device, the step of retrieving the configuration information and the step of wirelessly transmitting the configuration information using the captured energy of the interrogation signal.

4. The method of claim 3, wherein the passive interrogation interface device is a passive RFID tag device, the external interrogator is a RFID tag reading device, and the interrogation signal is a RF.

5. The method of claim 2, comprising:
performing, using a power source dedicated to the interrogation interface device via the interrogation interface device, the step of retrieving the configuration information and/or the step of wirelessly transmitting the configuration information.

6. The method of claim 1,
wherein the memory is embedded in the interrogation interface device.

7. The method of claim 1, comprising:
invalidating a previously existing configuration information in the memory prior to performing the step of programming the remote unit.

8. The method of claim 7,
wherein the step of storing the configuration information into the memory is performed after performing the step of programming the remote unit.

9. The method of claim 7, comprising:
confirming that the remote unit has been successfully programmed with the software/firmware after performing the step of programming the remote unit,
wherein the step of storing the configuration information into the memory is performed when the step of confirming confirms that the remote unit has been successfully programmed.

10. The method of claim 1,
wherein the step of storing the configuration information into the memory is performed after performing the step of programming the remote unit.

11. The method of claim 10, comprising:
confirming that the remote unit has been successfully programmed with the software/firmware after performing the step of programming the remote unit,
wherein the step of storing the configuration information into the memory is performed when the step of confirming confirms that the remote unit has been successfully programmed.

12. The method of claim 1,
wherein the configuration information stored in the memory includes one or more of tag-permanent values, manufacturer-locked values, and field-use values.

13. The method of claim 12,
wherein the tag-permanent values include a serial number of the interrogation interface device,
wherein the manufacturer-locked values include one or more of a CAGE code, a part/model identification, a serial identification, a date of manufacture, and an identification information, and
wherein the field-use values include one or more of a configuration code, a date code, and a condition code.

14. A remote unit, comprising:
a programming controller configured to control the programming of the remote unit;
a program memory configured to store the program of the remote unit, and operatively connected to the programming controller;
an interrogation memory configured to store the configuration data for the remote unit, and operatively connected to the programming controller; and
an interrogation interface device operatively connected to the programming controller,
wherein the programming controller is configured to program the program memory with software/firmware that establishes a remote unit configuration and is configured to store configuration information corresponding to the remote unit configuration into the interrogation memory, and
wherein the interrogation interface device is configured to be externally activated by an external interrogator, and to wirelessly communicate the configuration information from the interrogation memory to the external interrogator upon receiving an interrogation signal from the external interrogator.

15. The remote unit of claim 14,
wherein the interrogation interface device is configured to capture energy from the interrogation signal transmitted from the external interrogator and configured to transmit the configuration information using the captured energy of the interrogation signal.

16. The remote unit of claim 14,
wherein the interrogation interface device is a passive RFID tag device, the external interrogator is a RFID tag reading device, and the interrogation signal is a RF interrogation signal.

17. The remote unit of claim 14, comprising:
a power source dedicated to the interrogation interface device,
wherein the interrogation interface device is configured to retrieve the configuration information from the memory and/or transmit the configuration using the power source.

18. The remote unit of claim 14,
wherein the memory is embedded in the interrogation interface device.

19. (canceled)

20. (canceled)

21. (canceled)

22. (canceled)

23. (canceled)

24. (canceled)

25. (canceled)

26. A support equipment for programming a remote unit, comprising:
a programming module configured to:
program the remote unit with software/firmware to establish a remote unit configuration; and
store configuration information corresponding to the remote unit configuration into a memory of the remote unit operatively connected with an interrogation interface device of the remote unit,
wherein the interrogation interface device is configured to be externally activated by an external interrogator, and to wirelessly communicate the configuration information from the memory to the external interrogator upon receiving an interrogation signal from the external interrogator.

27. The support equipment of claim 26,
wherein the programming module is configured to invalidate a previously existing configuration information in the memory prior to programming the remote unit.

28. (canceled)

29. The support equipment of claim 27,
wherein the programming module is configured to confirm that the remote unit has been successfully programmed, and configured to store the configuration information into the memory when it has confirmed that the remote unit has been successfully programmed.

30. The support equipment of claim 26,
wherein the programming module is configured to store the configuration information into the memory after programming the remote unit.

31. The support equipment of claim 30,
wherein the programming module is configured to confirm that the remote unit has been successfully programmed, and configured to store the configuration information into the memory when it has confirmed that the remote unit has been successfully programmed.

32. The support equipment of claim 26,
wherein the configuration information stored in the memory include one or both of manufacturer-locked values and field-use values.

33. The support equipment of claim 32,
wherein the manufacturer-locked values includes one or more of a CAGE code, a part/model identification, a serial identification, a date of manufacture, and an identification information, and
wherein the field-use values includes one or more of a configuration code, a date code, and a condition code.
